(19) United States
(12) Patent Application Publication
(10) Pub. No.: US 2018/0135988 A1
(43) Pub. Date: May 17, 2018

(54) SYSTEMS AND METHODS FOR MARKING WAYPOINT LOCATIONS

(71) Applicant: RADICAL ELECTRONICS PTY LTD., BENTLEIGH EAST (AU)

(72) Inventors: ABRAHAM M. CYPRYS, BENTLEIGH EAST (AU); MICHAEL FITZALLEN, VICTORIA (AU)

(73) Assignee: RADICAL ELECTRONICS PTY LTD., BENTLEIGH EAST (AU)

(21) Appl. No.: 15/815,941

(22) Filed: Nov. 17, 2017

(30) Foreign Application Priority Data
Nov. 17, 2016 (AU) 2016904704

(51) Int. Cl. G01C 21/20; G06F 13/38

(52) U.S. Cl. CPC G01C 21/20; G01S 15/96; G06F 2213/3852; G06F 13/387

(57) ABSTRACT

A waypoint translation device, comprising: an input for receiving a first waypoint data sentence in a first format from a first device, the first waypoint data sentence comprising a set of geographical coordinates of a waypoint; at least one processor for generating a second waypoint data sentence in a second format, the second waypoint data sentence including the set of geographical coordinates; and an output for outputting the second waypoint data sentence to a second device.

### RELATED APPLICATION

This application claims priority from Australian provisional patent application number 2016904704, filed Nov. 17, 2016, the content of which is hereby incorporated by reference in its entirety.

### TECHNICAL FIELD

Embodiments relate generally to systems and methods for marking waypoint locations.

### BACKGROUND

Marine fishing vessels tend to carry separate GPS and fish finder units on board. These devices can both generate and store geographical waypoints or markers which can be used to mark geographical points of interest, such as schools of fish, refuelling depots or geological features. There are pros and cons to storing waypoints on each type of device. A benefit of fish finders is that they allow users to mark waypoints at geographical locations other than the current location of the fish finder, enabling after-the-event waypoint marking of sites of interest. GPS units typically only allow users to mark waypoints in realtime, each waypoint associated with the realtime location of the GPS unit. GPS units do, however, provide storage for many more waypoints than the typical fish finder. GPS units are also able to use waypoints for navigational purposes, such as controlling auto-pilot equipment, plotting lay-lines etc.

Many GPS and fish finder units include functionality to communicate waypoint (and other) information between one another to maximise the benefits of both a vessel's GPS and its fish finder. These units tend to use a standard communications protocol, such as National Marine Electronics Association (NMEA) protocol number 0183 or similar to communicate. However, whilst some GPS and fish finder manufacturers follow the strict protocols set out in the NMEA-0183 protocol, other manufacturers deviate from the standard, preventing devices using an NMEA standard from communicating with their devices. An example of this is the Furuno® brand of fish finder, examples of which transmit waypoint information in a different format to that defined by the NMEA. This different format cannot be read by most non-Furuno® made GPS units.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Embodiments of the disclosure provide a waypoint translation device, comprising an input for receiving a first waypoint data sentence in a first format from a first device, the first waypoint data sentence comprising a set of geographical coordinates of a waypoint; at least one processor for generating a second waypoint data sentence in a second format, the second waypoint data sentence including the set of geographical coordinates; and an output for outputting the second waypoint data sentence to a second device.

The first device may comprises a fish finder. The second device may comprise a GPS navigation unit

The second format may be associated with a National Marine Electronics Association (NMEA) protocol such as NMEA-0183 or NMEA-2000. The first format may be associated with a non-NMEA protocol.

The received waypoint data sentence may be converted to a NMEA WPL-type sentence.

The waypoint translation device may further comprise a serial to TTL converter for converting serial data received from the first device to TTL data for digital processing. Additionally or alternatively, the waypoint translation device may further comprise a TTL to serial converter for converting parallel digital data output from the output to serial data to the second device.

The waypoint translation device may further comprise: a second input for receiving location data comprising a second set of geographic coordinates from the second device; and a second output for outputting the location data to the first device. The at least one processor may be operable to convert the location data received from the second device into a different format to be output to the first device.

Embodiments of the disclosure also provide a system comprising the waypoint translation device described above in combination with the first and second devices described above wherein the first device is configured to send the first waypoint data sentence to the input of the waypoint translation device; and wherein the second device is configured to receive the second waypoint data sentence from the output of the waypoint translation device.

Embodiments of the disclosure also provide a system comprising: the waypoint translation device described above in combination with a remote waypoint controller operatively coupled to the waypoint translation device, the remote waypoint controller comprising an input device for receiving a user input, the remote waypoint controller operable, on receipt of user input at the input device, to cause the at least one processor to generate a third waypoint data sentence in the second format for output to the second device at the output.

The remote waypoint controller may be wirelessly coupled to waypoint translation device.

The remote waypoint controller may comprise a smartphone.

The system may further comprise the first device and the second device described above.

Embodiments of the disclosure also provide a method of translating geographical waypoints, comprising: receiving a first waypoint data sentence in a first format from a first device, the first waypoint data sentence comprising a set of geographical coordinates of a waypoint; generating a second waypoint data sentence in a second format, the second waypoint data sentence including the set of geographical coordinates; and outputting the second waypoint data sentence to a second device.

Generating the second waypoint data sentence may comprise: extracting a longitude coordinate and a latitude coordinate of the set of geographical coordinates from the first waypoint data sentence; and inputting the extracted longitude and latitude coordinates into the second waypoint data sentence.

Generating the second waypoint data sentence may further comprise: inputting one or more of a name and a number associated with the geographical coordinates into the second waypoint data sentence.

Generating the second waypoint data sentence may further comprise: generating a checksum based on the information stored in the second waypoint data sentence; and inputting the checksum into the second waypoint data sentence.

The first device may comprises a fish finder. The second device may comprise a GPS navigation unit.

The second format may be associated with a National Marine Electronics Association (NMEA) protocol, such as NMEA-0183 or NMEA-2000. The first format may be associated with a non-NMEA protocol.

The received waypoint data sentence may be converted to a NMEA WPL-type sentence.

The received waypoint data may be received in serial. In which case, the method may further comprise converting the serial received waypoint data for into TTL formatted data.

The method may further comprise: converting the output waypoint data to serial format for transmission.

The method may further comprise: receiving a third waypoint data sentence from the first device in a third format, the third waypoint data sentence comprising a second set of geographical coordinates associated with the location of the first or the second device; receiving a signal from a remote waypoint controller indicative of a user input at the remote waypoint controller; in response to the signal, generating a fourth waypoint data sentence in the second format, the fourth waypoint data sentence comprising the second set of geographical coordinates; and sending the fourth waypoint data sentence to the second device.

The signal from the remote waypoint controller may be received wirelessly. The remote waypoint controller may comprise a smartphone.

Embodiments of the disclosure also provide a method, comprising: receiving a first waypoint data sentence from a first device or a second device in a first format, the first waypoint data sentence comprising a set of geographical coordinates associated with the location of the first device or the second device; receiving a signal from a remote waypoint controller indicative of a user input at the remote waypoint controller; in response to the signal, generating a second waypoint data sentence in a second format, the second waypoint data sentence comprising the set of geographical coordinates; and sending the second waypoint data sentence to the second device.

The signal from the remote waypoint controller may be received wirelessly. For example, the remote waypoint controller may comprises a smartphone.

### BRIEF DESCRIPTION OF THE DRAWINGS

Embodiments will now be described in further detail, by non-limiting example only, with reference to the accompanying drawings, in which:

FIG. 1 is a schematic diagram of a system according to an embodiment of the disclosure;

FIG. 2 is a schematic diagram of a variation of the system shown in FIG. 1;

FIG. 3 is a detail schematic of the waypoint translation device shown in FIG. 1;

FIG. 4 is a flow diagram of a process performed by the waypoint translation device of FIG. 1;

FIG. 5 is a flow diagram of a process performed by the waypoint translation device of FIG. 1;

FIG. 6 is a flow diagram of a process performed by the waypoint translation device of FIG. 1; and

FIG. 7 is a flow diagram of a process performed by the waypoint translation device of FIG. 1.

### DETAILED DESCRIPTION

Embodiments described herein provide a translation device which enables data transfer between GPS and fish finder units communicating using different protocols. Particularly, embodiments enable communication between devices using a NMEA protocol, such as NMEA-0183 or NMEA-2000, and devices using the Furuno® proprietary protocol. Such communication is aided by way of a translation device configured to monitor an output stream from one device and translate information having one format into another, different format readable by another device.

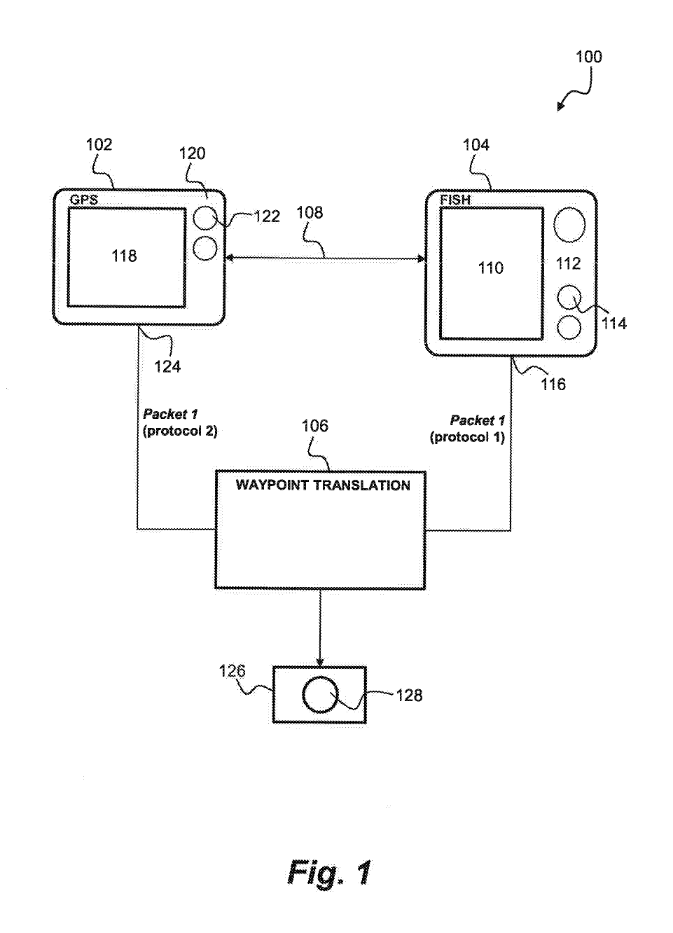

As an example, FIG. 1 provides a schematic illustration of a system 100 in accordance with some embodiments of the disclosure. The system 100 comprises a GPS unit 102, a fish finder 104 and a waypoint translation device 106.

The GPS unit 102 and the fish finder 104 may be operatively coupled to one another via one or more wired or wireless interconnects 108 to provide the fish finder 104 with geographical location data generated by the GPS unit 102. In some embodiments, the fish finder 104 may have its own inbuilt GPS, in which case this connection may not be required. In some embodiments, the one or more wired or wireless interconnects 108 may comprise a converter, adapter or gateway (not shown) operable to convert data transmitted between the GPS unit 102 and the fish finder 104 into different formats. For example, where the GPS unit 102 communicates using NMEA-2000 and the fish finder 104 communicates using NMEA-0183, the interconnect(s) 108 may be operable to convert NMEA-0183 data into NMEA-2000 data and vice-versa. Such data may include dynamic GPS data associated with the current position of the GPS unit 102.

The fish finder 104 is provided with a user interface comprising a display 110 which graphically displays measurements of reflected sound received at a submerged antenna (not shown), together with an input device 112 which allows the user to operate the fish finder 104. The input device 112 may be implemented in hardware using, for example, hard buttons. Additionally or alternatively, the input device 112 may be implemented in software using a touch screen integrated into the display 110. The input device 112 may comprise a waypoint “Mark” button 114. When the waypoint button 114 is pressed by the user, the fish finder 104 generates a waypoint sentence comprising geographical location (waypoint) data. The geographical waypoint data generated by the fish finder 104 may be associated with the current location of the fish finder or with a location different to the current location which has been chosen by the user upon interaction with the user interface. As such, it will be appreciated that geographical waypoint data is distinguished from GPS location data in that GPS data is dynamically updated based on the position of a GPS receiver, whereas geographical waypoint data is not dependent on the location of a GPS receiver. Instead, geographical waypoint data is data which is associated with a geographical location that a user wishes to record so that it can be recalled at a later time or date.

The fish finder further comprises at least one serial waypoint output 116 that outputs the waypoint data in a format or communications protocol used by the fish finder 104, hereinafter referred to as a first communications protocol (protocol 1). The fish finder waypoint output 116 is operatively coupled to an input of the waypoint translation device 106.

The GPS unit 102 is also provided with a user interface comprising a display 118 and a input device 120. The input device may comprise a waypoint “Mark” button 122 which, when pressed by a user, causes the GPS unit 102 to generate a waypoint sentence comprising geographical location data associated with the current location of the GPS unit. The GPS unit 102 is further provided with at least one serial waypoint input 124 configured to receive serial waypoint data in a format associated with a communications protocol used by the GPS unit 102, hereinafter referred to as a second communications protocol (protocol 2). An output of the waypoint translation device 106 is communicatively coupled to the waypoint input of the GPS unit 102.

The system may also comprises a remote waypoint controller 126 communicatively coupled to the waypoint translation device 106. The remote waypoint controller 126 comprises a waypoint input device 128, such as a button. In response to a user pressing interacting with the waypoint input device 128, remote waypoint controller 126 may cause the waypoint translation device 106 to output waypoint data in the second format to the GPS unit 102, causing the GPS unit 102 to store a waypoint associated with the current geographical position of the GPS unit 102. The remote waypoint controller 126 may be physically connected to the waypoint translation device 106. Alternatively the remote waypoint controller 126 may be a wireless device operable to be wirelessly coupled to the waypoint translation device 106 in any known manner. In some embodiments, the remote waypoint controller 126 may be implemented on a smartphone running software configured to wirelessly communicate with the waypoint translation device 106.

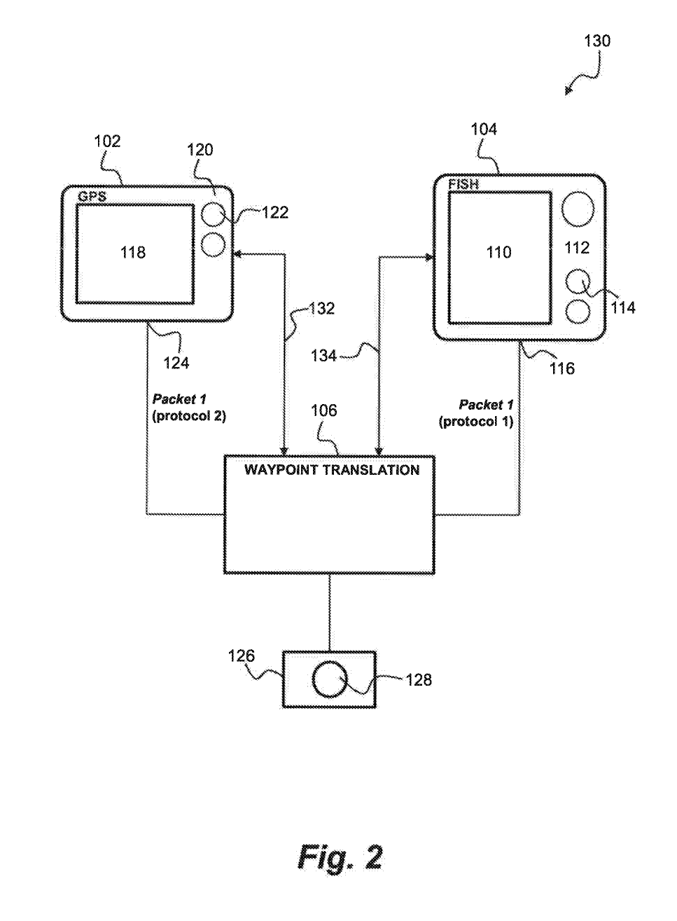

FIG. 2 is a schematic diagram of a variation of the system 100 shown in FIG. 1, where like parts have been denoted with like numbering. In the system 130 shown in FIG. 1, instead of there being provided one or more separated wired or wireless interconnects 108 as present in the system 100 of FIG. 1, the GPS unit 102 and the fish finder 104 may be operatively coupled to one another via the waypoint translation device 104, via wired or wireless interconnects 132, 134, for transmission of geographical location data generated by the GPS unit 102 to the fish finder 104. In which case, the waypoint translation device 104 may be operable to convert data transmitted between the GPS unit 102 and the fish finder 104 into different formats. For example, where the GPS unit 102 communicates using NMEA-2000 and the fish finder 104 communicates using NMEA-0183, the waypoint translation device 106 may be operable to convert NMEA-0183 data received from the fish finder into NMEA-2000 data for onward transmission to the GPS unit 102, and vice-versa.

It will be appreciated that in some embodiments, the GPS location data may be communicated via the same communications path as that which is used to transmit or receive waypoint data. For example, GPS location data may be output to the waypoint translation device 106 from the waypoint input 124. In which case, interconnect 132 may not be required. In such cases, the GPS unit 102 may be operable to communicate using the NMEA-2000 protocol, which supports bidirectional communication. Additionally or alternatively, the fish finder may be operable to receive GPS location data from the waypoint translation device 106 over the same communications path as that which is used to transmit waypoint data, i.e. via the serial waypoint output 116. In which case, interconnect 134 may not be required.

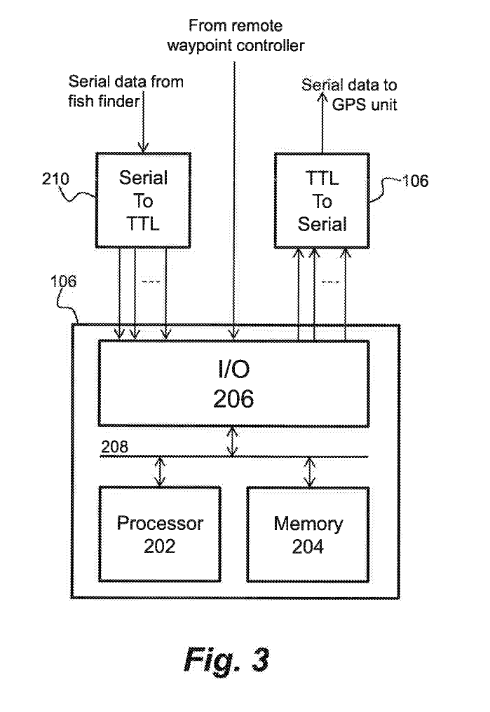

FIG. 3 schematically illustrates the waypoint translation device 106 in more detail.

The translation device 106 comprises a processor 202, memory 204, and an input/output (I/O) module 206 for receiving data from the fish finder 104 and waypoint controller 108 and sending data to the GPS unit 102. The processor 202, memory 204 and input/output module 206 communicate via a communications bus 208 in any manner known in the art.

In some embodiments, both the GPS unit 102 and the fish finder 104 are configured to communicate waypoint information in serial, for example using RS-232 or RS-485, whereas the waypoint translation device 106 may be configured to receive parallel data. In such circumstances, the system 100 may further comprises a serial to transistor-transistor logic (TTL) converter 210 to convert serial data output from the fish finder waypoint output 116 into TTL format for input to the I/O module and a TTL to serial converter 212 to convert digital data output from the I/O module to serial data for input to the waypoint input 112 of the GPS unit 102. In other embodiments, the waypoint translation device 106 may be configured to receive serial data or the serial to TTL converter 210 and the TTL to serial converter 212 may be integral to the waypoint translation device 106.

The waypoint translation device 106 may be implemented in hardware or software or a combination thereof. In some embodiments, the waypoint translation device 106 is implemented using a microcontroller, an example of which is the ATmega328P from Atmel®.

A problem arises when the first communications protocol used by the fish finder 104 is different to the second communications protocol used by the GPS unit 102. As will be explained in more detail below, the waypoint translation device 106 is configured to convert data in the format associated with the first protocol (a first format) to data in a format associated with the second protocol (a second format) so that the GPS unit 102 can successfully interpret data output from the fish finder 104.

In the following examples, the second communications protocol used by the GPS unit 102 is NMEA-0183 and the first communications protocol used by the fish finder is an unconventional non-NMEA protocol, such as the Furuno® protocol. It will be appreciated that other embodiments of the waypoint translation device 106 may equally be able to interpret and convert data in formats other than those described in the following examples. In some embodiments, for example, the second communications protocol is NMEA-2000 and the waypoint translation device 106 is operable to translate NMEA-2000 into a non-NMEA protocol, such as the Furuno® protocol.

NMEA-0183

NMEA-0183 sentences are transmitted and received using standard serial transmission protocol RS-232, and in some cases RS-485. These are both electrical standards which define the voltages, timing, and format of the bytes of serial data. In some instances, GPS unit 102 may be configured to transmit and receive both RS-485 and RS-232 encoded data.

A typical NMEA-0183 sentence format is shown below.

$(Sentence ID), (Field1), (Field2), (Field 3), . . . , (Field N)*(Checksum)<CR><LF>

All sentences begin with a ‘$’ character immediately followed by a five character sentence ID. Each sentence contains a series of ASCII data fields separated by a comma. Fields with no information are left empty, with no spaces taken up (but with the separation commas left intact).

An asterisk designates the end of the last data field and is followed by a two digit hexadecimal checksum. The checksum is the hexadecimal result of the logical function “Exclusive OR” (XOR) of all the characters in the sentence between, but not including, the ‘$’ and the ‘*’.

Following the checksum, the sentence is terminated with a carriage return character and a line feed character.

The maximum length of a sentence is 82 characters including the return and line feed characters.

There are several types of NMEA-0183 sentence indicated by a standard NMEA-0183 message description included in the first field of a sentence. Examples of these message descriptions include RMC (recommended minimum data for GPS), GGA (Fix information), GLL (Latitude/longitude data) and WPL (waypoint location information). The first field of each sentence also includes a two letter prefix which indicates the source of the sentence, or alternatively, the company code. As an example, the prefix “GP” in the first field of a sentence indicates that it was sourced from a GPS, whereas the prefix “SD” means that it was sourced from a depth sounder. The majority of fish finders on the market do not have inbuilt GPS transceivers. Accordingly, at least one of the type RMC, GGA and GLL sentences may be transmitted via interconnect 108 to the fish finder 104 from the GPS unit 102.

Examples of the above NMEA-0183 sentence types will now be described. For data translation purposes, the two letter prefix is functionally irrelevant and in the following examples, to avoid confusion, the prefix has been replaced by “--”.

A typical NMEA-0183 RMC sentence format is shown below.

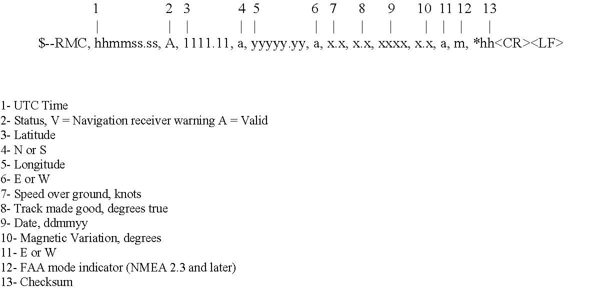

An example of an RMC sentence is as follows.

$GPRMC,081513,A,3803.866,S,14505.705,E,4.87,119.35,010616,11.76,E,A*0A<CR><LF>

A typical NMEA-0183 GGA sentence format is shown below.

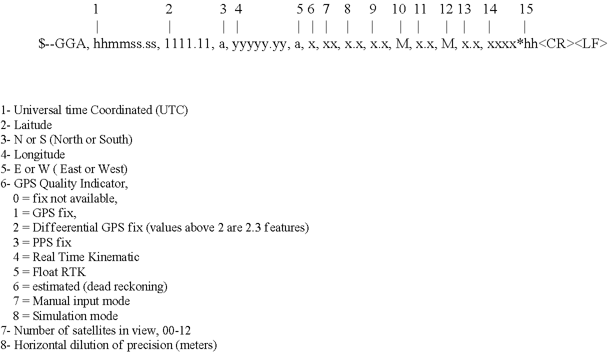

An example of an GGA sentence is as follows.

$GPGGA,081513,3803.866,S,14505.705,E,1,10,0.81,4.01,M,−0.65,M,,*75<CR><LF>

A typical NMEA-0183 GLL sentence format is shown below.

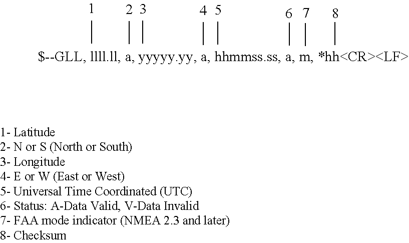

An example of an GLL sentence is as follows.

$GPGLL,3803.866,S,14505.705,E,081513,A,A*53<CR><LF>

A typical NMEA-0183 WPL sentence format is shown below.

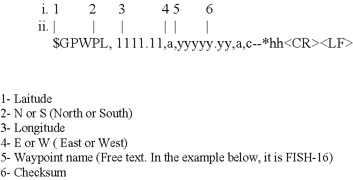

An example of an WPL sentence is as follows.

$GPWPL,3755.8301,S,14503.5277,E,Fish-16*42<CR><LF>

Non-NMEA Protocols

In some embodiments, the fish finder 106 is configured to transmit waypoint data using a non-NMEA protocol. In this example, this first communications protocol take a slightly different format to that of NMEA-0183. Firstly, the sentence description is not a recognised NMEA sentence description. Instead, the sentences transmitted and received at the fish finder 104 have the sentence description “TLL”.

A typical TLL sentence is as follows:

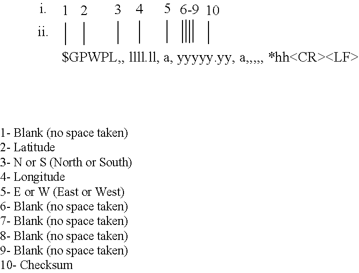

An example of a TLL sentence is as follows:

$SDTLL,,3804.2360,S,14507.6760,E,,,,*41<CR><LF>

It can be seen from the above that much of the same information as that contained in a NMEA WPL sentence is provided in a TLL sentence, but the position of the information in the sentence is not standard.

Accordingly, in order to communicate waypoint information between the GPS unit 102 and the fish finder 104, the waypoint translation device 106 must be provided to translate the information received in TLL format from the fish finder 104 into WPL format for transmission to the GPS unit 102. FIGS. 3 to 6 illustrate processes associated with performing this translation.

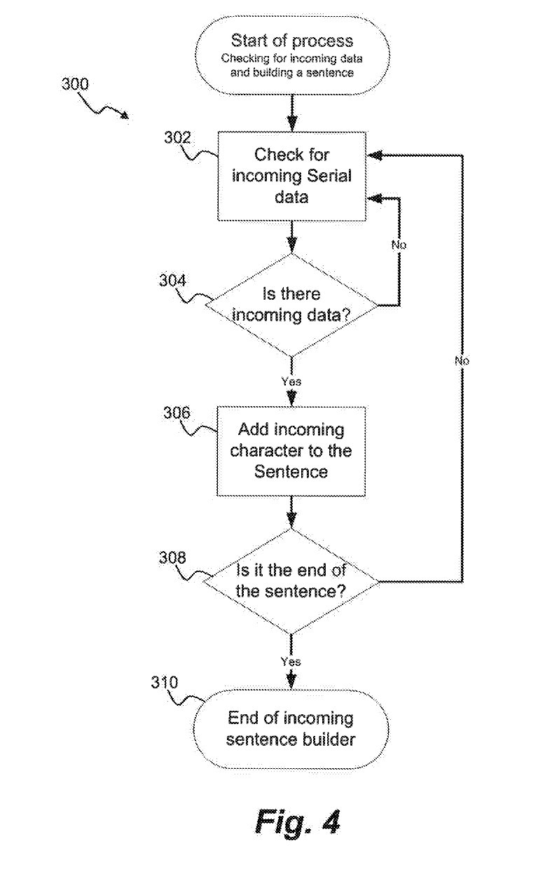

FIG. 4 illustrates a process 300 executed by the waypoint translation device 106 in accordance with embodiments of the disclosure. The process is repeated constantly while the translation device 106 is active (e.g. switched on).

At step 302, the translation device 106 polls for incoming data from the fish finder 104. If it is determined at step 304 that no data has been received from the fish finder 104, the process transitions back to step 302 where polling for incoming data is repeated. If it is determined at step 304 that data is being received at the I/O device 206, then at step 306 incoming characters are read and stored in a data buffer or other memory.

At step 308, the process 300 then checks that the received character is indicative of the end of a sentence, i.e., the received character is an end-of-sentence character such as “<CR><LF>”. If it is determined that the end of a sentence has not been reached, the process 300 returns to step 302, where the next character is read, stored and added to the sentence. If on the other hand it is determined that the end of the sentence has been reached, the incoming sentence is finalised at step 310. The process 300 is repeated constantly while the device is switched on to ensure no incoming sentences (or characters thereof) are missed.

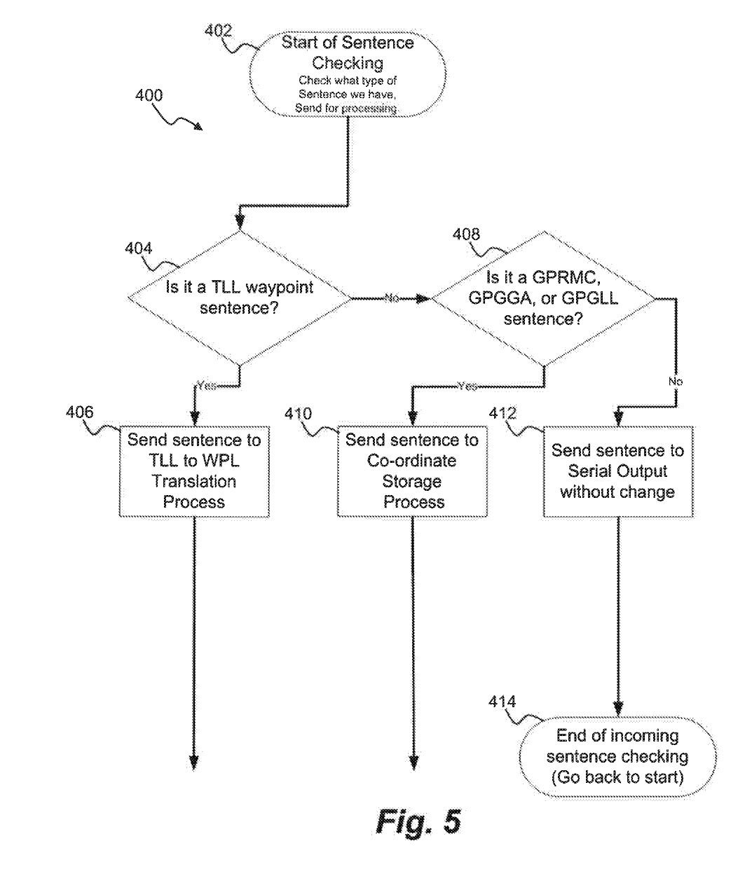

As soon as the data buffer is flagged as containing a complete sentence, the sentence is analysed to determine how it is to be handled by the translation device 106. A process 400 for performing such analysis is shown in FIG. 5.

Firstly, at step 402, the message description field of the sentence is parsed to check what type of sentence has been received. At step 404, if the sentence is determined to be in the TTL format, the sentence is flagged at step 406 for translation into WPL format. If the sentence is found not to be in the TTL format, optionally at step 408, a determination is also made as to whether the sentence is an RMC, GGA or GLL sentence received from a GPS device (“GP”). If this is the case, the sentence is sent to a co-ordinate storage process at step 410 to store the coordinates contained in the sentence. If the sentence is not a GPRMC, GPGGA or GPGLL sentence, then at step 412 the sentence is sent to the I/O module 206 to be sent to the GPS unit 102 without change. The process 400 then ends at step 414 and analysis of the next received sentence is commenced.

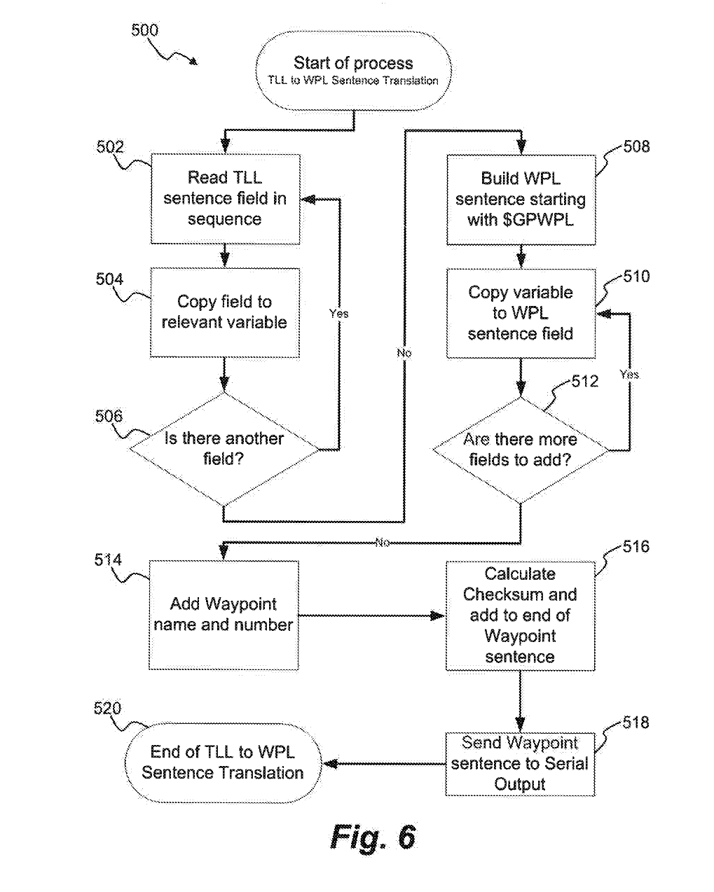

A process 500 for generating a WPL format sentence based on a received TLL format sentence is shown in FIG. 6. An array, “WPLSentence” is created in memory which provides a WPL format template, as shown below.

WPLsentence=“$GPWPL,”+WPTlat+“,”+WPTns+“,”+WPTlong+“,”+WPTew+“,Fish−”+WaypointNumber+“*”;

Referring to FIG. 6, at step 502, the first relevant (non-empty) field in the TLL sentence, e.g. TLL latitude, is read from the sentence and copied to the relevant variable of the WPLsentence array, e.g. “WPTlat” at step 504. At step 506, the process 500 checks whether there are any further unchecked fields in the received TLL sentence. If unchecked fields exist, the process 500 repeats steps 502, 504 and 506 until there are no unchecked fields in the received TLL sentence. At step 508, the full sentence is built and all field variables are copied into the new WPL sentence at step 510. When it is determined that there are no more fields to add to the WLP sentence at step 512, a waypoint name and number are added to the sentence (as these are not typically present in a TLL sentence) at step 514. A new checksum is then calculated at step 516 associated with the new WPL sentence and at step 518 the complete WPL sentence is sent to the I/O module 206 for transmission to the GPS unit 102 and the process ends (520). The process is repeated for each new TLL sentence received by the waypoint translation device 106.

In some embodiments, the step of calculating the checksum (step 516) involves calculating the logical “XOR” of all the characters in the WPL sentence between, but not including the “$” and the “*” symbols. The result is a 2 digit hexadecimal number which can be stored in the checksum field of the WPL sentence.

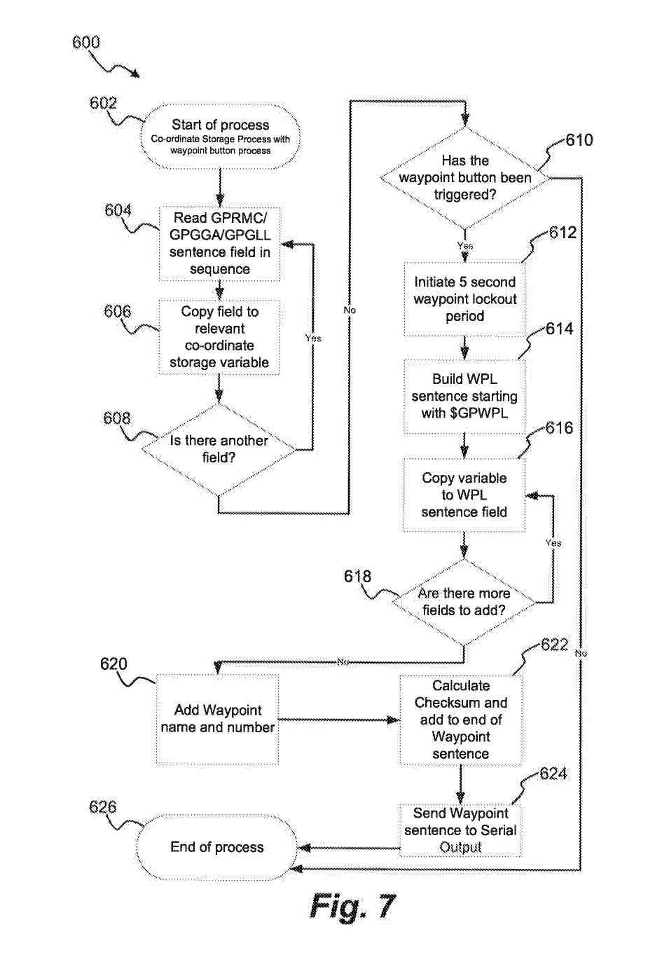

As mentioned above, in some embodiments, a remote waypoint controller 126 is provided which allows a user to mark a waypoint on the GPS unit 102 remotely without needing to interact with either the GPS unit 106's waypoint button 122 or the fish finder 104's waypoint button 114. FIG. 7 provides a flow diagram of an exemplary process 600 for operating the remote waypoint controller 126. As mentioned above, one or more of an RMC, GGA or GLL NMEA-0183 sentence may be transmitted either from the fish finder 104 or the GPS unit 102. It is noted that not all GPS devices are configured to transmit all three of the above references sentence types. Accordingly, preferably the waypoint translation device 106 is configured to recognise any one of these sentence types.

Referring again to FIG. 7, at step 602, the RMC, GGA or GLL sentence is input into the process 600. At step 604, the first relevant (non-empty) field in the RMC/GGA/GLL sentence is read from the sentence and copied to the relevant variable of the WPLsentence array, e.g. “WPTlat” at step 606. At step 608, the process 600 checks whether there are any further unchecked fields in the received sentence. If unchecked fields exist, the process 600 repeats steps 604, 606 and 608 until there are no unchecked fields in the received sentence.

At step 610, the process 600 checks to see whether the remote waypoint controller 126 has signalled a user interaction (e.g. the user has triggered the waypoint input device 128). If it is determined at step 610 that the input device 128 has been triggered, then the received RMC, GGA or GLL sentence is discarded and the process ends (626). If, however, it is determined at step 610 that the remote waypoint controller 126 has been triggered, the process 600 triggers a lockout of the waypoint controller 126 at step 612 for a predetermined period of time, e.g. 5 seconds. Any event at the waypoint controller 126 during this time period are discarded. This ensures that identical WPL sentences will not be generated in quick succession in the event that the waypoint button 128 is continuously triggered (e.g. held down for an extended period).

At step 614, the full WPL sentence is built and all field variables are copied into the new WPL sentence at step 616. When it is determined that there are no more fields to add to the WLP sentence at step 618, a waypoint name and number may be added to the sentence at step 620. A new checksum may then be calculated at step 622 associated with the new WPL sentence and at step 624 the complete WPL sentence is sent to the I/O module 206 for transmission to the GPS unit 102 and the process ends (626).

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A waypoint translation device, comprising:
an input for receiving a first waypoint data sentence in a first format from a first device, the first waypoint data sentence comprising a set of geographical coordinates of a waypoint;
at least one processor for generating a second waypoint data sentence in a second format, the second waypoint data sentence including the set of geographical coordinates; and
an output for outputting the second waypoint data sentence to a second device.

2. The waypoint translation device of claim 1, wherein the first device comprises a fish finder.

3. The waypoint translation device of claim 1, wherein the second device comprise a GPS navigation unit

4. The waypoint translation device of claim 1, wherein the second format is associated with a National Marine Electronics Association (NMEA) protocol and wherein the first format is associated with a non-NMEA protocol.

5. The waypoint translation device of claim 4, wherein the NMEA protocol is NMEA-0183 or NMEA-2000, and wherein the received waypoint data sentence is converted to a NMEA WPL-type sentence.

6. The waypoint translation device of claim 1, further comprising a serial to TTL converter for converting serial data received from the first device to TTL data for digital processing, and a TTL to serial converter for converting parallel digital data output from the output to serial data to the second device.

7. The waypoint translation device of claim 1, further comprising:
a second input for receiving location data comprising a second set of geographic coordinates from the second device; and
a second output for outputting the location data to the first device, wherein the at least one processor is operable to convert the location data received from the second device into a different format to be output to the first device.

8. A system comprising:
the waypoint translation device of claim 1; and
a remote waypoint controller operatively coupled to the waypoint translation device, the remote waypoint controller comprising an input device for receiving a user input,
the remote waypoint controller operable, on receipt of user input at the input device, to cause the at least one processor to generate a third waypoint data sentence in the second format for output to the second device at the output.

9. The system of claim 8, wherein the remote waypoint controller is wirelessly coupled to waypoint translation device.

10. The system of claim 9, wherein the remote waypoint controller comprises a smartphone.

11. The system of claim 8, further comprising:
the first device; and
the second device.

12. A system, comprising:
a first device;
a second device;
the waypoint translation device of claim 1;
wherein the first device is configured to send the first waypoint data sentence to the input of the waypoint translation device; and
wherein the second device is configured to receive the second waypoint data sentence from the output of the waypoint translation device.

13. A method of translating geographical waypoints, comprising:
receiving a first waypoint data sentence in a first format from a first device, the first waypoint data sentence comprising a set of geographical coordinates of a waypoint;
generating a second waypoint data sentence in a second format, the second waypoint data sentence including the set of geographical coordinates; and
outputting the second waypoint data sentence to a second device.

14. The method of claim 13, wherein generating the second waypoint data sentence comprises:
extracting a longitude coordinate and a latitude coordinate of the set of geographical coordinates from the first waypoint data sentence; and
inputting the extracted longitude and latitude coordinates into the second waypoint data sentence.

15. The method of claim 14, wherein generating the second waypoint data sentence further comprises:
inputting one or more of a name and a number associated with the geographical coordinates into the second waypoint data sentence.

16. The method of claim 14, wherein generating the second waypoint data sentence further comprises:
generating a checksum based on the information stored in the second waypoint data sentence; and
inputting the checksum into the second waypoint data sentence.

17. The method of claim 13, wherein the first device comprises a fish finder, and wherein the second device comprise a GPS navigation unit.

18. The method of claim 13, wherein the second format is associated with a National Marine Electronics Association (NMEA) protocol and wherein the first format is associated with a non-NMEA protocol.

19. The method of claim 13, wherein the received waypoint data is received in serial, the method further comprising:
converting the serial received waypoint data for into TTL formatted data; and
converting the output waypoint data to serial format for transmission.

20. The method of claim 13, further comprising:
receiving a third waypoint data sentence from the first device in a third format, the third waypoint data sentence comprising a second set of geographical coordinates associated with the location of the first or the second device;
receiving a signal from a remote waypoint controller indicative of a user input at the remote waypoint controller;
in response to the signal, generating a fourth waypoint data sentence in the second format, the fourth waypoint data sentence comprising the second set of geographical coordinates; and
sending the fourth waypoint data sentence to the second device.

21. A method, comprising:
receiving a first waypoint data sentence from a first device or a second device in a first format, the first waypoint data sentence comprising a set of geographical coordinates associated with the location of the first device or the second device;
receiving a signal from a remote waypoint controller indicative of a user input at the remote waypoint controller;
in response to the signal, generating a second waypoint data sentence in a second format, the second waypoint data sentence comprising the set of geographical coordinates; and
sending the second waypoint data sentence to the second device.
